(19) United States
(12) Patent Application Publication
(10) Pub. No.: US 2020/0110348 A1
(43) Pub. Date: Apr. 9, 2020

(54) IMAGE FORMING APPARATUS

(71) Applicant: FUJI XEROX CO., LTD., Tokyo (JP)

(72) Inventor: Toru MORIOKA, Kanagawa (JP)

(73) Assignee: FUJI XEROX CO., LTD., Tokyo (JP)

(21) Appl. No.: 16/388,891

(22) Filed: Apr. 19, 2019

(30) Foreign Application Priority Data
Oct. 9, 2018 (JP) 2018-191103

(51) Int. Cl. G03G 15/06; G03G 15/08

(52) U.S. Cl. CPC G03G 15/065; G03G 15/0806

(57) ABSTRACT

An image forming apparatus includes a rotary image carrying unit, a charging unit that charges a surface of the image carrying unit, a developing unit that develops an electrostatic latent image formed on the surface of the image carrying unit, and an applying unit that applies, to the developing unit, a developing voltage having a reverse polarity to a polarity for image formation when an uncharged region of the image carrying unit reaches the developing unit at a start of the charging unit.

### CROSS-REFERENCE TO RELATED APPLICATIONS

This application is based on and claims priority under 35 USC 119 from Japanese Patent Application No. 2018-191103 filed Oct. 9, 2018.

### BACKGROUND

### (i) Technical Field

The present disclosure relates to an image forming apparatus.

### (ii) Related Art

There is an image forming apparatus configurated such that a charging voltage of a charging device and a developing bias voltage of a developing device are changed stepwise with a phase difference in order to prevent, when the surface of a photoconductor drum is charged by the charging device, a so-called fog in which toner adheres to the surface of the photoconductor drum due to a potential difference between a charging potential on the surface of the photoconductor drum and the developing bias voltage of the developing device.

Technologies related to this type of image forming apparatus have already been disclosed in, for example, Japanese Unexamined Patent Application Publication Nos. 2017-107075 and 2017-026679.

Japanese Unexamined Patent Application Publication No. 2017-107075 discloses a controller configurated such that, when a developing voltage applying unit starts to apply a developing voltage and developer carriers start to rotate in order from an image forming part on an upstream side in a movement direction at the start of image formation, the surface potential of the image carrier of each of the image forming parts other than the image forming part at the end of the upstream side in the movement direction is controlled so that a potential difference between the surface potential of the image carrier and the developing voltage becomes smaller than that during the image formation in a period from the start of application of the developing voltage by the developing voltage applying unit to the start of rotation of the developer carrier.

Japanese Unexamined Patent Application Publication No. 2017-026679 discloses the following technology. In a lowering process for stopping power supply to a charging device and a developing device, a control part sets a charging voltage to be generated by the charging device to become a second charging voltage having a smaller absolute value than a first charging voltage for forming an electrostatic latent image on an image carrier and also sets a developing bias that is a voltage to be applied to a developer carrier to become a second developing bias having a smaller absolute value than a first developing bias for developing the electrostatic latent image. When a portion of the surface of the image carrier where the second charging voltage is applied reaches a radiation position of an exposing device, the exposing device exposes the surface of the image carrier with light to neutralize charges on the surface. When a portion of the surface where the charges are neutralized reaches the developer carrier, the power supply to the charging device and the developing device is stopped. The exposing device stops light exposure when an uncharged portion of the surface of the image carrier that has passed by the charging device during the stop of power supply reaches the radiation position of the exposing device.

### SUMMARY

Aspects of non-limiting embodiments of the present disclosure relate to reduction of the occurrence of a case in which an uncharged region of an image carrying unit prior to raising a charging voltage of a charging unit moves to a developing unit and therefore toner of the developing unit adheres to the uncharged region of the image carrying unit compared with a case in which a voltage having a reverse polarity to that for image formation is not applied to the developing unit at the start of the charging unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus comprising a rotary image carrying unit, a charging unit that charges a surface of the image carrying unit, a developing unit that develops an electrostatic latent image formed on the surface of the image carrying unit, and an applying unit that applies, to the developing unit, a developing voltage having a reverse polarity to a polarity for image formation when an uncharged region of the image carrying unit reaches the developing unit at a start of the charging unit.

### BRIEF DESCRIPTION OF THE DRAWINGS

Exemplary embodiments of the present disclosure will be described in detail based on the following figures, wherein:

FIG. 1 is a schematic structural diagram illustrating an image forming apparatus according to a first exemplary embodiment of the present disclosure;

FIG. 2 is a structural diagram illustrating an image forming part of the image forming apparatus according to the first exemplary embodiment of the present disclosure;

FIG. 3 is a perspective view illustrating the structure of a charging device;

FIG. 4 is a sectional view illustrating a developing device;

FIG. 5 is a structural diagram illustrating a principal part of the image forming apparatus according to the first exemplary embodiment of the present disclosure;

FIG. 6 is a graph illustrating a surface potential of a photoconductor drum;

FIGS. 7A and 7B are graphs illustrating a charging bias voltage of a charging device and a developing bias voltage of a developing device in related art;

FIG. 8 is a graph illustrating a developing bias voltage of the developing device of the image forming apparatus according to the first exemplary embodiment of the present disclosure;

FIG. 9 is a graph illustrating a charging bias voltage of the charging device and the developing bias voltage of the developing device of the image forming apparatus according to the first exemplary embodiment of the present disclosure;

FIG. 10 is a block diagram illustrating a control device of the image forming apparatus according to the first exemplary embodiment of the present disclosure;

FIG. 11 is a graph illustrating a charging bias voltage in an image forming apparatus according to a second exemplary embodiment of the present disclosure;

FIG. 12 is a graph illustrating a reverse-polarity developing bias voltage in the image forming apparatus according to the second exemplary embodiment of the present disclosure;

FIG. 13 is a block diagram illustrating a control device of an image forming apparatus according to a third exemplary embodiment of the present disclosure;

FIG. 14 is a graph illustrating a relationship between a film thickness of a photoconductor drum and a reverse-polarity developing bias voltage in the image forming apparatus according to the third exemplary embodiment of the present disclosure; and

FIG. 15 is a graph illustrating a charging bias voltage in an image forming apparatus according to a fourth exemplary embodiment of the present disclosure.

### DETAILED DESCRIPTION

Exemplary embodiments of the present disclosure are described below with reference to the drawings.

### First Exemplary Embodiment

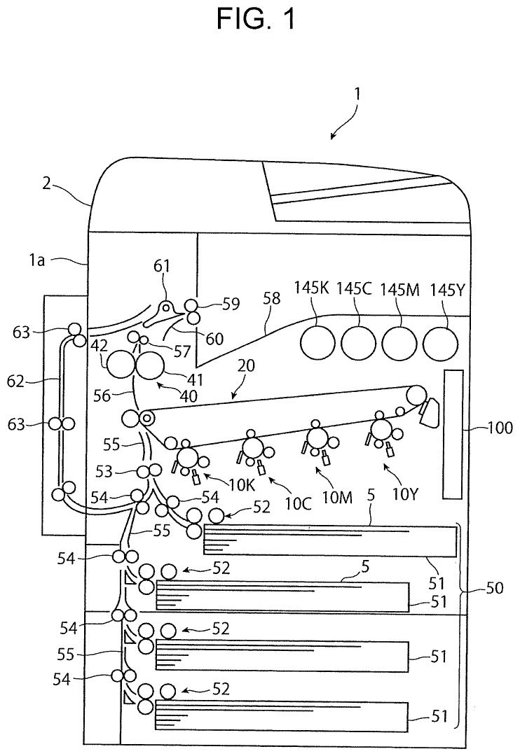

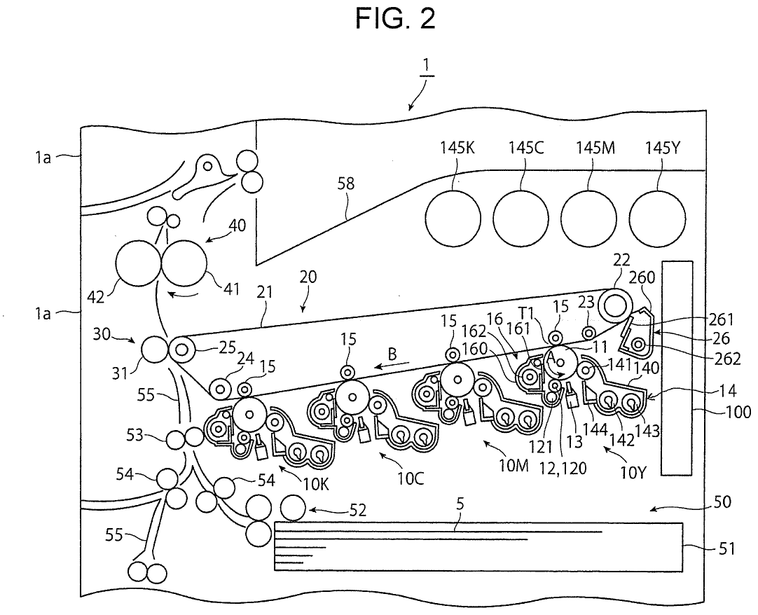

FIG. 1 and FIG. 2 illustrate an image forming apparatus according to a first exemplary embodiment of the present disclosure. FIG. 1 illustrates an overview of the image forming apparatus. FIG. 2 is an enlarged view of a principal part (such as image forming devices) of the image forming apparatus.

### <Overall Structure of Image Forming Apparatus>

An image forming apparatus 1 according to the first exemplary embodiment is, for example, a color printer. As illustrated in FIG. 1, the image forming apparatus 1 includes an image reading device 2 arranged at the upper end of an apparatus body 1a. The image reading device 2 reads an image of a document (not illustrated) while automatically transporting the document or reads an image of a document placed on a platen glass (not illustrated). The image forming apparatus 1 includes a so-called internal output type paper output part 58 on a right side below the image reading device 2. The paper output part 58 has a space for outputting recording paper 5 as an example of a recording medium having an image formed thereon.

The image forming apparatus 1 includes a plurality of image forming devices 10 that form toner images developed with toner serving as a developer, an intermediate transfer device 20 that carries the toner images formed by the image forming devices 10 and transports the toner images to a second transfer position where the toner images are finally secondly transferred onto the recording paper 5, a paper feeding device 50 that contains and transports sheets of desired recording paper 5 to be fed to the second transfer position of the intermediate transfer device 20, and a fixing device 40 that fixes the toner images secondly transferred onto the recording paper 5 by the intermediate transfer device 20. The apparatus body 1a is formed of a support structure member, an outside cover, and the like.

The image forming devices 10 are four dedicated image forming devices 10Y, 10M, 10C, and 10K that form toner images of four colors that are yellow (Y), magenta (M), cyan (C), and black (K), respectively. The four image forming devices 10 (Y, M, C, K) are arranged in line while being inclined within an internal space of the apparatus body 1a. Among the four image forming devices 10 (Y, M, C, K), the position of the image forming device 10Y for yellow (Y) is relatively high and the position of the image forming device 10K for black (K) is relatively low.

As illustrated in FIG. 2, each image forming device 10 (Y, M, C, K) includes a rotary photoconductor drum 11 as an example of an image carrying unit. For example, the following devices are arranged around the photoconductor drum 11. The devices are a charging device 12 that is an example of a charging unit that charges the peripheral surface of the photoconductor drum 11 where an image may be formed (image carrying surface) at a desired potential, an exposing device 13 that is an example of an electrostatic latent image forming unit that forms an electrostatic latent image (for each color) with a potential difference by irradiating the charged peripheral surface of the photoconductor drum 11 with light based on image information (signal), a developing device 14 that is an example of a developing unit that develops the electrostatic latent image into a toner image with toner of a corresponding color (Y, M, C, K) that serves as a developer 4, a first transfer device 15 that is an example of a first transfer unit that transfers the toner image onto the intermediate transfer device 20, and a drum cleaning device 16 that cleans the image carrying surface of the photoconductor drum 11 after first transfer by removing adherents such as residual toner adhering to the image carrying surface. In FIG. 2, reference symbols that represent the photoconductor drum 11, the charging device 12, and the like are assigned only to the image forming device 10Y for yellow (Y) and are omitted for the other image forming devices 10 (M, C, K).

The photoconductor drum 11 has an image carrying surface having a photoconductive layer (photosensitive layer) made of a photosensitive material on the peripheral surface of a cylindrical or columnar grounded conductive base. The photoconductor drum 11 is supported so as to rotate in a direction indicated by an arrow A by a driving force transmitted from a driving device (not illustrated).

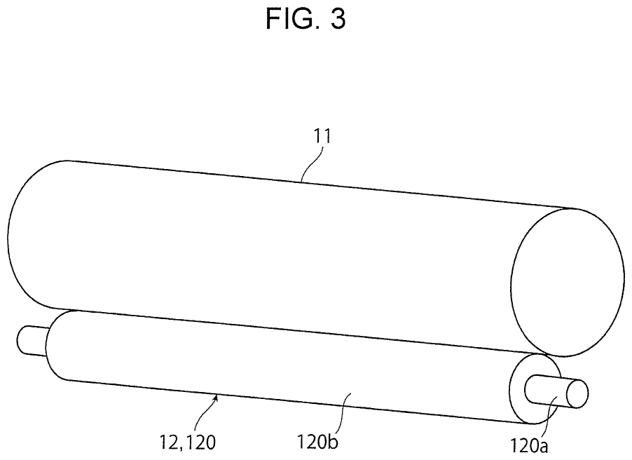

The charging device 12 includes a contact charging roller 120 arranged in contact with the photoconductor drum 11. The charging roller 120 has a cleaning roller 121 that cleans the surface of the charging roller 120. As illustrated in FIG. 3, the charging roller 120 includes a cylindrical metal core member 120a made of a metal such as stainless steel, and a conductive elastic layer 120b that coats the outer periphery of the metal core member 120a. As described later, the charging roller 120 is supplied with a charging voltage from a charging bias supply. If the developing device 14 performs reversal development, a voltage or current having a polarity identical to a charging polarity of the toner to be supplied from the developing device 14 (negative in this exemplary embodiment) is supplied as the charging voltage. The charging device 12 may be a non-contact charging device such as a scorotron arranged out of contact with the surface of the photoconductor drum 11.

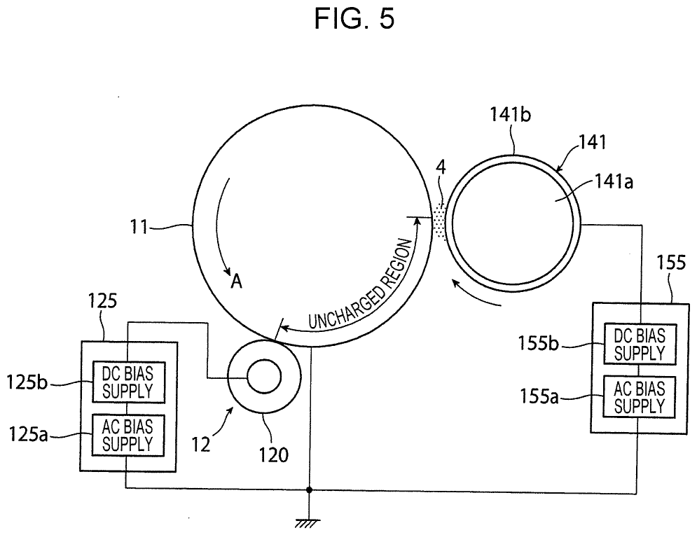

As illustrated in FIG. 5, the metal core member 120a of the charging roller 120 is supplied with a charging bias voltage from a charging bias supply 125. The charging bias voltage is a DC bias voltage obtained by superposing an AC bias voltage. The charging bias supply 125 includes an AC bias supply 125a that generates the AC bias voltage, and a DC bias supply 125b that generates the DC bias voltage.

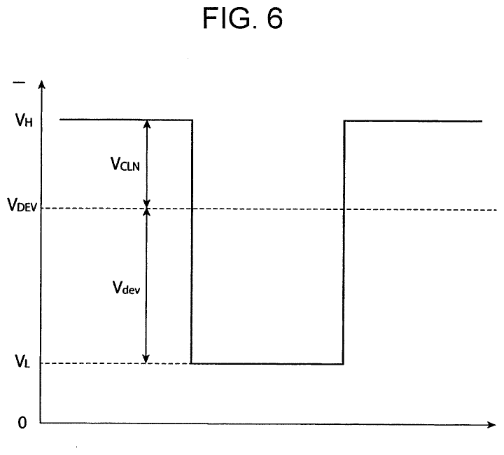

As illustrated in FIG. 6, the DC bias voltage of the charging bias voltage is a voltage for charging the surface of the photoconductor drum 11 at a dark portion potential V_{H} that is a predetermined charging potential. The charging bias voltage is not limited to the DC bias voltage obtained by superposing the AC bias voltage but may be the DC bias voltage alone.

The exposing device 13 includes a light emitting diode (LED) print head that forms an electrostatic latent image by irradiating the photoconductor drum 11 with light based on image information from a plurality of LEDs serving as light emitting elements arrayed in an axial direction of the photoconductor drum 11. The exposing device 13 may be an exposing device that scans the photoconductor drum 11 in the axial direction of the photoconductor drum 11 with deflected laser light based on image information.

As illustrated in FIG. 2, each developing device 14 includes a developing roller 141, an agitating supply member 142 such as a screw auger, an agitating transport member 143 such as a screw auger, and a layer thickness regulating member 144 arranged in a device housing 140 having an opening and a chamber containing the developer. The developing roller 141 is an example of a developer retaining unit that retains the developer and transports the developer to a developing region where the developing roller 141 faces the photoconductor drum 11. The agitating supply member 142 supplies the developer 4 to the developing roller 141 while agitating the developer 4. The agitating transport member 143 transports the developer 4 between the agitating supply member 142 and the agitating transport member 143 while agitating the developer 4. The layer thickness regulating member 144 regulates the amount (layer thickness) of the developer to be retained by the developing roller 141. The developer of each of the four colors is a two-component developer containing non-magnetic toner and a magnetic carrier. The developing device 14 is described later in detail.

The first transfer device 15 is a contact transfer device including a first transfer roller that rotates in contact with the periphery of the photoconductor drum 11 via an intermediate transfer belt 21 and is supplied with a first transfer voltage. As the first transfer voltage, a DC voltage having a reverse polarity to the charging polarity of the toner is supplied from a power supply (not illustrated).

The drum cleaning device 16 includes a partially open container body 160, a cleaning blade 161 arranged in contact with the peripheral surface of the photoconductor drum 11 after first transfer at a desired pressure to clean the peripheral surface by removing adherents such as residual toner, and a sending member 162 such as a screw auger that collects the adherents such as the toner removed by the cleaning blade 161 and sends the adherents to a collecting system (not illustrated).

The intermediate transfer device 20 is arranged above the image forming devices 10 (Y, M, C, K). For example, the intermediate transfer device 20 includes the intermediate transfer belt 21 that rotates in a direction indicated by an arrow B while passing through each first transfer position between the photoconductor drum 11 and the first transfer device 15 (first transfer roller), a plurality of belt support rollers 22 to 25 that rotatably support the intermediate transfer belt 21 in a desired state from the inner side, a second transfer device 30 that is an example of a second transfer unit arranged on an outer peripheral side (image carrying surface) of the intermediate transfer belt 21 supported on the belt support roller 25 to secondly transfer the toner images on the intermediate transfer belt 21 onto the recording paper 5, and a belt cleaning device 26 that cleans the outer peripheral surface of the intermediate transfer belt 21 by removing adherents such as residual toner or paper dust adhering to the outer peripheral surface after the intermediate transfer belt 21 has passed through the second transfer device 30.

For example, the intermediate transfer belt 21 is an endless belt manufactured by using a material obtained by dispersing a resistance regulator such as carbon black in a synthetic resin such as a polyimide resin or a polyamide resin. The belt support roller 22 is a driving roller to be rotationally driven by a driving device (not illustrated). The belt support roller 23 is a surfacing roller that defines an image forming surface of the intermediate transfer belt 21. The belt support roller 24 is a tension applying roller that applies tension to the intermediate transfer belt 21. The belt support roller 25 is a back-support roller for second transfer.

The second transfer device 30 is a contact transfer device including a second transfer roller 31 that rotates in contact with the peripheral surface of the intermediate transfer belt 21 at the second transfer position that is a portion of the outer peripheral surface of the intermediate transfer belt 21 supported on the belt support roller 25 in the intermediate transfer device 20 and is supplied with a second transfer voltage. As the second transfer voltage, a DC voltage having an identical or reverse polarity to the charging polarity of the toner is supplied to the second transfer roller 31 or the belt support roller 25 of the intermediate transfer device 20 from the power supply (not illustrated).

The belt cleaning device 26 includes a partially open container body 260, a cleaning blade 261 arranged in contact with the peripheral surface of the intermediate transfer belt 21 after second transfer at a desired pressure to clean the peripheral surface by removing adherents such as residual toner, and a sending member 262 such as a screw auger that collects the adherents such as the toner removed by the cleaning blade 261 and sends the adherents to the collecting system (not illustrated).

The fixing device 40 includes a roller-shaped or belt-shaped heating rotator 41 and a roller-shaped or belt-shaped pressurizing rotator 42 arranged in a housing (not illustrated) having an input port and an output port for the recording paper 5. The heating rotator 41 rotates in a direction indicated by an arrow and is heated by a heating unit so that the surface temperature is kept at a predetermined temperature. The pressurizing rotator 42 rotates in association with the heating rotator 41 while being in contact with the heating rotator 41 at a predetermined pressure substantially in an axial direction of the heating rotator 41. In the fixing device 40, a contact part between the heating rotator 41 and the pressurizing rotator 42 serves as a fixing process part that performs a desired fixing process (heating and pressurizing).

As illustrated in FIG. 1, the paper feeding device 50 is arranged below the image forming devices 10 (Y, M, C, K). For example, the paper feeding device 50 includes a plurality of (or a single) paper containers 51 containing stacked sheets of recording paper 5 of desired sizes and types, and sending devices 52 that send the sheets of recording paper 5 one by one from the paper containers 51. For example, each paper container 51 is drawable at the front of the apparatus body 1a (side facing a user during an operation).

Examples of the recording paper 5 include plain paper, thin paper such as tracing paper, and an OHP sheet for use in an electrophotographic copying machine or printer. To further improve the smoothness of a fixed image surface, it is desirable that the surface of the recording medium 5 be as smooth as possible. For example, coated paper obtained by coating the surface of plain paper with a resin or the like and so-called thick paper such as art paper for printing whose basis weight is relatively large may be used suitably.

A paper feed path 55 is provided between the paper feeding device 50 and the second transfer device 30. The paper feed path 55 is formed of one or a plurality of paper transport roller pairs 53 and 54 and transport guides (not illustrated) that transport, to the second transfer position, the recording paper 5 sent out from the paper feeding device 50. In the paper feed path 55, the paper transport roller pair 53 arranged immediately upstream of the second transfer position is, for example, a pair of rollers that adjust a timing to transport the recording paper 5 (registration rollers). A paper transport path 56 is provided between the second transfer device 30 and the fixing device 40. The paper transport path 56 is formed of, for example, a transport guide that transports, to the fixing device 40, the recording paper 5 sent out from the second transfer device 30 after second transfer. A paper output path 60 is provided near an output port for the recording paper 5 in the apparatus body 1a. The paper output path 60 includes a paper output roller pair 59 that outputs, to the paper output part 58 formed in the apparatus body 1a, the recording paper 5 sent out from the fixing device 40 by outlet rollers 57 after fixing.

A switching gate 61 that switches paper transport paths is provided between the fixing device 40 and the paper output roller pair 59. The paper output roller pair 59 may switch its rotation direction between a forward direction (output direction) and a backward direction. To form images on both sides of the recording paper 5, the rotation direction of the paper output roller pair 59 is switched from the forward direction (output direction) to the backward direction after the trailing edge of the recording paper 5 having an image formed on one side has passed by the switching gate 61. The switching gate 61 switches the transport paths of the recording paper 5 to be transported in the backward direction by the paper output roller pair 59 and the recording paper 5 is transported to a duplex transport path 62 extending substantially in the vertical direction along the side of the apparatus body 1a. The duplex transport path 62 includes paper transport roller pairs 63 and transport guides that transport the recording paper 5 to the paper transport roller pair 53 so that the recording paper 5 is reversed.

In FIG. 1, reference symbol 145 (Y, M, C, K) represents a toner cartridge arranged in a direction intersecting the drawing sheet to contain a developer containing at least toner to be supplied to the developing device 14 of the corresponding image forming device 10 (Y, M, C, K).

In FIG. 1, reference symbol 100 represents a control device that controls an overall operation of the image forming apparatus 1. The control device 100 is described later in detail.

### <Operation of Image Forming Apparatus>

A basic image forming operation of the image forming apparatus 1 is described below.

Description is made of an operation in a full-color mode in which a full-color image that is a combination of four-color (Y, M, C, K) toner images is formed by using the four image forming devices 10 (Y, M, C, K).

When the image forming apparatus 1 has received command information for requesting a full-color image forming operation (printing) from a user interface or a printer driver (not illustrated), the four image forming devices 10 (Y, M, C, K), the intermediate transfer device 20, the second transfer device 30, the fixing device 40, and the like are activated.

In each image forming device 10 (Y, M, C, K), as illustrated in FIG. 2, the photoconductor drum 11 first rotates in the direction indicated by the arrow A and the charging device 12 charges the surface of the photoconductor drum 11 at a desired polarity (negative polarity in the first exemplary embodiment) and at a desired potential. Then, the exposing device 13 irradiates the charged surface of the photoconductor drum 11 with light emitted based on an image signal obtained such that image information input to the image forming apparatus 1 is converted into each color component (Y, M, C, K). Thus, an electrostatic latent image of each color component is formed on the surface with a desired potential difference.

Then, each image forming device 10 (Y, M, C, K) performs development such that toner of a corresponding color (Y, M, C, K) that is charged at a desired polarity (negative polarity) is supplied from the developing roller 141 and electrostatically adheres to the electrostatic latent image of each color component that is formed on the photoconductor drum 11. Through the development, the electrostatic latent image of each color component that is formed on the photoconductor drum 11 is developed into a toner image of each of the four colors (Y, M, C, K) with the toner of the corresponding color.

When the toner images of the respective colors that are formed on the photoconductor drums 11 of the image forming devices 10 (Y, M, C, K) are transported to the first transfer positions, the first transfer devices 15 firstly transfer the toner images of the respective colors so as to sequentially superpose the toner images on the intermediate transfer belt 21 of the intermediate transfer device 20 that rotates in the direction indicated by the arrow B.

In each image forming device 10 (Y, M, C, K) that has finished the first transfer, the drum cleaning device 16 cleans the surface of the photoconductor drum 11 by removing adherents in a scraping manner. Thus, the image forming device 10 (Y, M, C, K) is ready for a subsequent image forming operation.

Then, the intermediate transfer device 20 carries the firstly transferred toner images and transports the toner images to the second transfer position through the rotation of the intermediate transfer belt 21. The paper feeding device 50 sends desired recording paper 5 to the paper feed path 55 in synchronization with the image forming operation. In the paper feed path 55, the paper transport roller pair 53 serving as the registration rollers feeds the recording paper 5 to the second transfer position in synchronization with a transfer timing.

At the second transfer position, the second transfer device 30 secondly transfers the toner images on the intermediate transfer belt 21 collectively onto the recording paper 5. In the intermediate transfer device 20 that has finished the second transfer, the belt cleaning device 26 cleans the surface of the intermediate transfer belt 21 by removing adherents such as toner remaining on the surface after the second transfer.

Then, the recording paper 5 having the toner images secondly transferred thereonto is released from the intermediate transfer belt 21 and then transported to the fixing device 40 via the paper transport path 56. In the fixing device 40, the unfixed toner images are fixed to the recording paper 5 after the second transfer through a necessary fixing process (heating and pressurizing) by causing the recording paper 5 to enter and pass through the contact part between the rotating heating rotator 41 and the rotating pressurizing rotator 42. During the image forming operation for forming an image only on one side of the recording paper 5, the recording paper 5 after the fixing is output to, for example, the paper output part 58 provided at the top of the apparatus body 1a by the paper output roller pair 59.

Through the operation described above, the recording paper 5 having a full-color image that is a combination of the four-color toner images is output.

### <Structure of Developing Device>

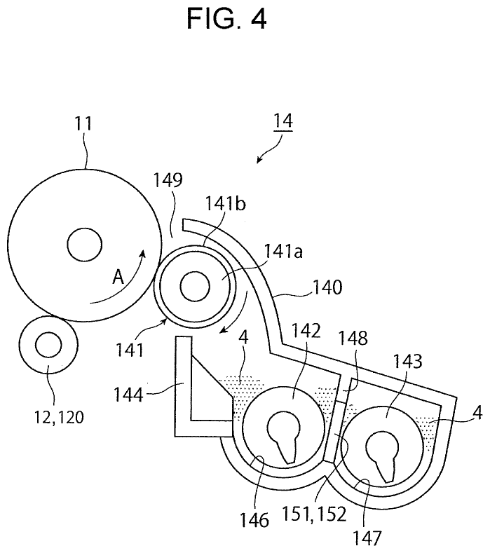

FIG. 4 is a sectional view illustrating the developing device of the image forming apparatus according to the first exemplary embodiment.

As illustrated in FIG. 4, the developing device 14 includes the device housing 140. The device housing 140 has two developer containing chambers 146 and 147 containing the developer 4. The two developer containing chambers 146 and 147 are partitioned by a partition wall 148. An opening 149 is provided in a region of the device housing 140 that faces the photoconductor drum 11. In the device housing 140, the developing roller 141 that is the example of the developer retaining unit is partially exposed at the opening 149 so as to be rotatable in an arrow direction. The developing roller 141 includes a magnet roller 141a and a developing sleeve 141b. The magnet roller 141a is an example of a magnetic field generating unit fixed inside the developing roller 141 and having a magnetic pole with a desired polarity that is arranged at a desired position. The developing sleeve 141b is an example of a developer transport unit arranged on the outer periphery of the magnet roller 141a so as to be rotatable at a desired rotational speed in the arrow direction. The magnet roller 141a has a developing pole that magnetically attracts the developer 4 to form a magnetic brush of the developer 4 in the developing region where the developing roller 141 faces the photoconductor drum 11. The developer 4 attracted to the surface of the developing sleeve 141b by a magnetic force of the magnet roller 141a moves to the developing region where the developing roller 141 faces the photoconductor drum 11 along with the rotation of the developing sleeve 141b. The toner of the developer 4 that has moved to the developing region is supplied for development by adhering to the surface of the photoconductor drum 11 depending on an electrostatic latent image formed on the surface of the photoconductor drum 11. The developing sleeve 141b is formed into a cylindrical shape from a non-magnetic material such as aluminum or non-magnetic stainless steel.

The agitating supply member 142 is rotatably arranged in the one developer containing chamber 146. The agitating transport member 143 is rotatably arranged in the other developer containing chamber 147. The partition wall 148 that partitions the two developer containing chambers 146 and 147 has openings 151 and 152 at both longitudinal ends. The developer 4 is exchanged between the agitating supply member 142 and the agitating transport member 143 through the openings 151 and 152.

As illustrated in FIG. 5, a developing bias voltage is applied to the developing sleeve 141b by a developing bias supply 155 that is an example of an applying unit. The developing bias voltage is a DC bias voltage obtained by superposing an AC bias voltage. The developing bias supply 155 includes an AC bias supply 155a that generates the AC bias voltage, and a DC bias supply 155b that generates the DC bias voltage.

As illustrated in FIG. 6, the DC bias voltage of the developing bias voltage is set to a voltage that is lower by a predetermined value than the dark portion potential V_{H} that is the charging potential of the photoconductor drum 11. A difference between an exposed portion potential V_{L} of the photoconductor drum 11 and a developing bias voltage V_{DEV} (V_{L}−V_{DEV}) is a developing potential V_{dev} for developing an electrostatic latent image by causing the toner to adhere to the photoconductor drum 11. A difference between the charging potential V_{H} of the photoconductor drum 11 and the developing bias voltage V_{DEV} (V_{H}−V_{DEV}) is a cleaning potential V_{CLN} for preventing adhesion of the toner or carrier that causes a fog on the surface of the photoconductor drum 11.

The rotational speed of the developing sleeve 141b is determined depending on the productivity of the image forming apparatus 1 that is determined based on a rotational speed of the photoconductor drum 11. The rotational speed of the developing sleeve 141b increases as the number of sheets of recording paper 5 of an A4 size (LEF) to be printed per unit time increases to 44 pages per minute (ppm), 55 ppm, and 70 ppm as the productivity of the image forming apparatus 1.

As illustrated in FIG. 5, the developer 4 retained on the surface of the developing roller 141 is formed into a magnetic brush by the magnetic force of the developing magnetic pole (not illustrated) of the magnet roller 141a in the developing region where the developing roller 141 faces the surface of the photoconductor drum 11. The toner in the magnetic brush of the developer 4 retained on the surface of the developing roller 141 reciprocally flies between the developing sleeve 141b and the photoconductor drum 11 by the AC bias voltage of the developing bias voltage applied to the developing sleeve 141b. As illustrated in FIG. 6, development is performed such that the toner adheres to the surface of the photoconductor drum 11 depending on the potential difference between the DC bias voltage V_{DEV} applied to the developing sleeve 141b and the exposed portion potential V_{L} of the photoconductor drum 11 (V_{L}−V_{DEV}).

Thus, the developer 4 retained on the surface of the developing roller 141 is constantly in contact with the surface of the photoconductor drum 11 not only after the start of rotation of the developing sleeve 141b but also during a stop of the developing sleeve 141b.

### <Characteristic Structure of Image Forming Apparatus>

At the start of the image forming operation of the image forming apparatus 1, each image forming device 10 (Y, M, C, K) starts to rotationally drive the photoconductor drum 11 and the charging roller 120 charges the surface of the photoconductor drum 11 at a desired charging potential.

It is known that, if the photoconductor drum 11 is immediately charged so that the surface potential of the photoconductor drum 11 becomes the dark portion potential V_{H} during the image formation and the developing bias voltage is immediately applied to the developing roller 141, the potential difference between the surface potential of the photoconductor drum 11 and the developing bias voltage V_{DEV} applied to the developing roller 141 may cause a so-called fog in which the toner adheres to the surface of the photoconductor drum 11 or so-called beads carry over or beads carry out (BCO) in which the carrier in the developer 4 is developed to adhere to the surface of the photoconductor drum 11.

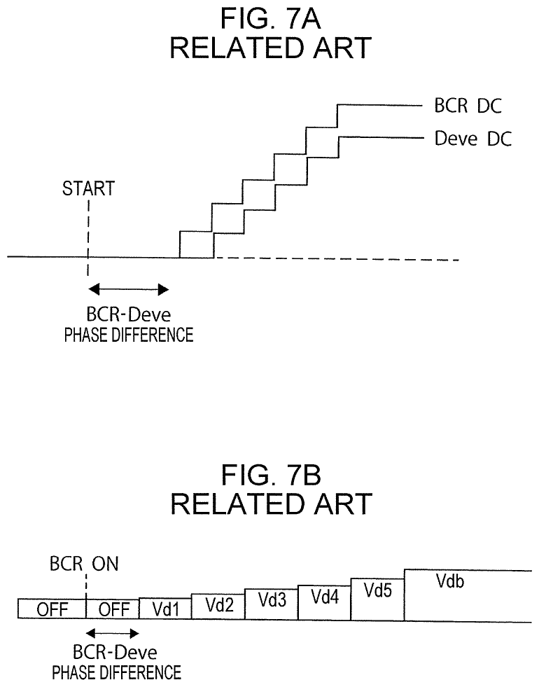

In a related-art image forming apparatus, as illustrated in FIG. 7A, at the start of the image forming operation, the charging potential of the photoconductor drum 11 and the developing bias voltage are changed stepwise so that the potential difference between the charging potential of the photoconductor drum 11 and the developing bias voltage becomes equal to or smaller than a predetermined value in order to prevent adhesion of the toner or carrier that causes the fog on the surface of the photoconductor drum 11.

In the related-art image forming apparatus, as illustrated in FIG. 7B, at the start of charging the photoconductor drum 11, a region where the surface potential of the photoconductor drum 11 is 0 V and the developing bias potential applied to the developing roller 141 is 0 V exists until the surface of the photoconductor drum 11 that is not charged by the charging roller 120 reaches the developing device 14, that is, over a phase difference corresponding to a distance from the charging roller 120 to the developing roller 141 of the developing device 14 in a circumferential direction of the photoconductor drum 11.

When the uncharged region where the surface potential of the photoconductor drum 11 is 0 V reaches the developing device 14, as illustrated in FIG. 5, there is a technical problem of the so-called fog in which the toner in the developer 4 retained in the form of the magnetic brush on the surface of the developing roller 141 adheres to the surface of the photoconductor drum 11 due to the van der Waals force.

There is not much toner adhering to the surface of the photoconductor drum 11 due to the van der Waals force when the uncharged region where the surface potential of the photoconductor drum 11 is 0 V reaches the developing device 14. However, the adhesion of the toner to the surface of the photoconductor drum 11 inevitably occurs at the start over an area given by a product of a total axial length of the photoconductor drum 11 and a circumferential length of the photoconductor drum 11 from the charging roller 120 to the developing roller 141. The toner adhering to the surface of the photoconductor drum 11 results in cumulative and unnecessary consumption of the toner in the developing device 14.

This exemplary embodiment provides the applying unit that applies, to the developing unit, a developing voltage having a reverse polarity to that for the image formation when the uncharged region of the image carrying unit reaches the developing unit at the start of the charging unit.

To give a further description, as illustrated in FIG. 5, this exemplary embodiment provides the developing bias supply 155 that is the example of the applying unit that applies, to the developing roller 141 of the developing device 14, a developing bias voltage having a reverse polarity to that for the image formation when the uncharged region (0 V) of the photoconductor drum 11 that exists between the charging roller 120 and the developing roller 141 of the developing device 14 reaches the developing device 14 at the start of charging the surface of the photoconductor drum 11 by the charging roller 120 to start the image forming operation.

At the start of charging the surface of the photoconductor drum 11 by the charging roller 120, the developing bias supply 155 causes the DC bias supply 155b to apply, to the developing roller 141 of the developing device 14, a developing bias voltage having a reverse polarity (positive polarity) to that for the image formation. For example, the developing bias voltage having the reverse polarity (positive polarity) to that for the image formation and applied to the developing sleeve 141b of the developing roller 141 by the DC bias supply 155b is set to a value equal to the so-called cleaning potential V_{CLN} corresponding to the absolute value of the potential difference between the charging potential V_{H} of the photoconductor drum 11 and the developing bias voltage V_{DEV} applied to the developing roller during the image formation (=|V_{H}−V_{DEV}|). Specifically, the reverse-polarity developing bias voltage to be applied to the developing roller 141 is set to about +90 to 150 V.

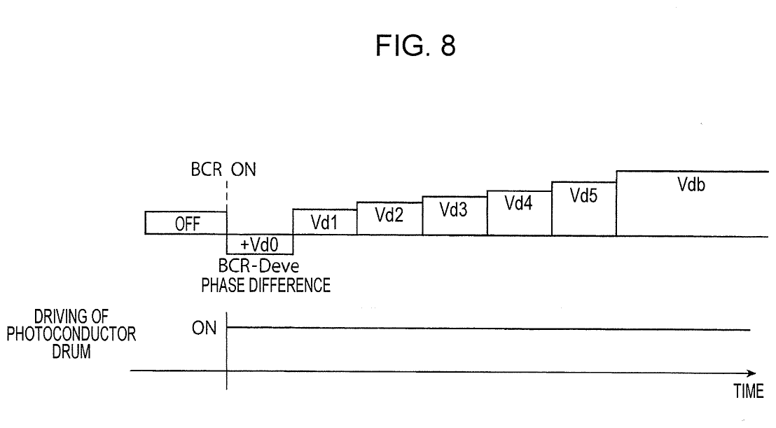

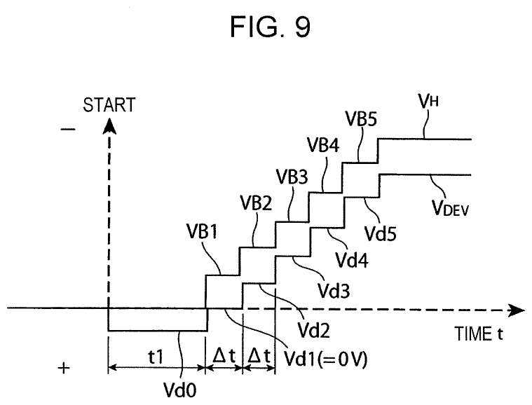

As illustrated in FIG. 8, the application of the reverse-polarity developing bias voltage is started simultaneously with the start of rotation of the photoconductor drum 11. The reverse-polarity developing bias voltage is applied during a time t1 (see FIG. 9) until a charged region VB1 of the surface of the photoconductor drum 11 that is charged by the charging roller 120 reaches the position of the developing roller 141 of the developing device 14.

As illustrated in FIG. 9, the surface of the photoconductor drum 11 is charged by the charging roller 120. At this time, the charging potential of the surface of the photoconductor drum 11 that is charged by the charging roller 120 is switched in a plurality of (six) steps so as to rise to the desired charging potential V_{H}. After the surface potential of the photoconductor drum 11 is raised to a potential VB1 in a first step, the surface potential is raised to a potential VB2 in a second step, a potential VB3 in a third step, a potential VB4 in a fourth step, and a potential VB5 in a fifth step in each desired time Δt. Finally, the surface potential is set to the desired charging potential V_{H}.

As illustrated in FIG. 8 and FIG. 9, the developing bias voltage to be applied to the developing roller 141 is similarly switched in a plurality of (six) steps so as to rise to the desired developing bias potential V_{DEV}. The developing bias voltage is switched to a potential Vd1 in a first step (=0 V) in association with the potential VB1 in the first step on the surface of the photoconductor drum 11 while keeping a desired potential difference (VB1−Vd1). Then, the developing bias voltage is raised to Vd2 to Vd5 associated with the potential VB2 in the second step to the potential VB5 in the fifth step on the surface of the photoconductor drum 11, respectively. Finally, the developing bias voltage is set to the desired developing bias voltage V_{DEV}. The developing bias voltages Vd2 to Vd5 in the respective steps are set so that the potential difference from the surface potential VB of the photoconductor drum 11 (VB−Vd) becomes equal to or smaller than the cleaning potential V_{CLN} that is a desired value.

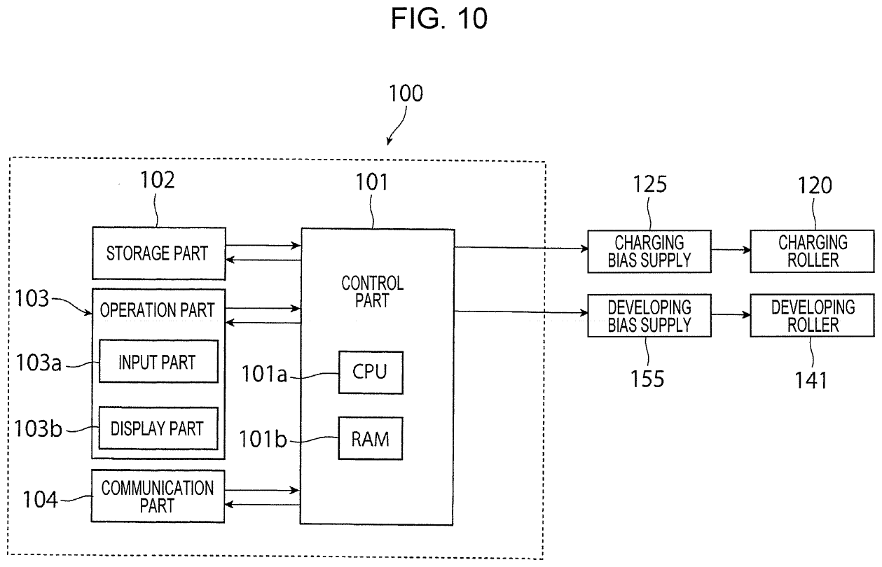

FIG. 10 is a block diagram illustrating the control device of the image forming apparatus 1 according to the first exemplary embodiment.

The control device 100 includes a control part 101, a storage part 102, an operation part 103, and a communication part 104.

The control part 101 includes a central processing unit (CPU) 101a and a random access memory (RAM) 101b. The control part 101 controls the image forming operation of the image forming apparatus 1 by executing a program stored in the storage part 102. The control part 101 controls the storage part 102, the operation part 103, or the communication part 104 and communicates with a client terminal such as a personal computer via the communication part 104.

The operation part 103 includes an input part 103a and a display part 103b. The input part 103a is used by a user for inputting, for example, the type of the recording paper 5, the number of prints, simplex or duplex printing, and an image forming mode such as a full-color mode or a monochrome mode and for giving an instruction to start the image forming operation with a start button. For example, the display part 103b displays image forming conditions input via the input part 103a and a status of the image forming apparatus 1.

The control part 101 controls the developing bias voltage to be applied to the developing roller 141 of the developing device 14 via the developing bias supply 155.

The control part 101 controls the charging bias voltage to be applied to the charging roller 120 of the charging device 12 via the charging bias supply 125.

### <Characteristic Operation of Image Forming Apparatus>

In the image forming apparatus 1 according to the first exemplary embodiment, the charging potential of the photoconductor drum 11 and the developing bias voltage of the developing device are switched as follows at the start of the image forming operation.

In the image forming apparatus 1, as illustrated in FIG. 5, the surface of the photoconductor drum 11 is charged by the charging roller 120 and the developing bias voltage is applied to the developing roller 141 of the developing device 14 at the start of the image forming operation. At this time, as illustrated in FIG. 9, the surface potential of the photoconductor drum 11 that is charged by the charging roller 120 is switched by the control part 101 of the control device 100 so as to rise stepwise to the potential VB1 in the first step to the potential VB5 in the fifth step in each desired time Δt.

The developing bias voltage to be applied to the developing roller 141 of the developing device 14 is set to a reverse-polarity developing bias voltage +Vd0 during the time t1 until the uncharged region (=0 V) of the surface of the photoconductor drum 11 reaches the developing roller of the developing device 14.

Then, the developing bias voltage to be applied to the developing roller 141 of the developing device 14 is switched to the developing bias potential Vd1 in the first step to the developing bias potential Vd5 in the fifth step in association with the charging potential VB1 in the first step to the charging potential VB5 in the fifth step on the surface of the photoconductor drum 11, respectively.

Therefore, the reverse-polarity developing bias voltage +Vd0 is applied to the developing roller 141 of the developing device 14 during the time t1 until the uncharged region (=0 V) of the surface of the photoconductor drum 11 reaches the developing roller 141 of the developing device 14 after the start of rotation of the photoconductor drum 11.

Thus, the toner charged at the negative polarity in the developer 4 retained on the surface of the developing roller 141 is still retained electrostatically on the surface of the developing roller 141 by the reverse-polarity developing bias voltage +Vd0 applied to the developing roller 141. As a result, the adhesion of the toner in the developer 4 retained on the surface of the developing roller 141 to the surface of the photoconductor drum 11 is prevented or suppressed even if the toner is in contact with the surface of the photoconductor drum 11. The carrier in the developer 4 retained on the surface of the developing roller 141 is magnetically attracted and retained by the magnetic pole of the magnet roller in the developing roller 141. Thus, adhesion of the carrier to the surface of the photoconductor drum 11 is prevented.

### Second Exemplary Embodiment

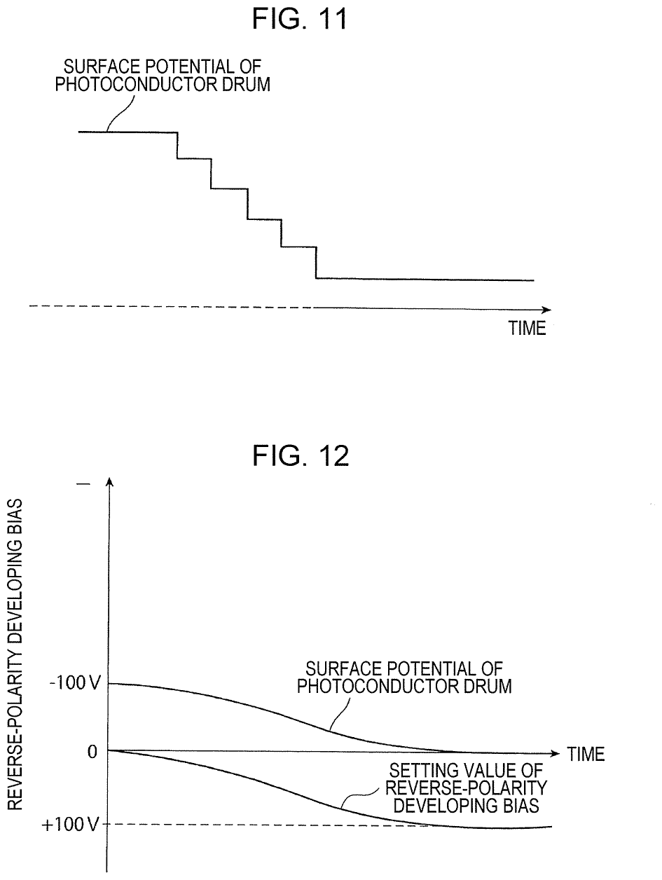

FIG. 11 illustrates an image forming apparatus according to a second exemplary embodiment of the present disclosure. In the second exemplary embodiment, the applying unit changes the value of the developing voltage having the reverse polarity to that for the image formation and applied to the developing unit depending on an elapsed time from the end of a previous image forming operation. Further, the applying unit changes the developing voltage to be applied to the developing unit depending on the elapsed time from the end of the previous image forming operation so that the difference from the charging potential of the image carrying unit falls within a predetermined range.

That is, in the second exemplary embodiment, as illustrated in FIG. 11, the charging potential of the surface of the photoconductor drum 11 that is charged by the charging roller 120 is lowered stepwise to 0 V at the end of the image forming operation in a similar manner to that at the start of the image forming operation.

As illustrated in FIG. 11, the surface potential of the photoconductor drum 11 may remain charged at about −100 V without completely attenuating to 0 V at the stop of rotation. The charged state of the surface of the photoconductor drum 11 at about −100 V attenuates gradually. Depending on characteristics of the photoconductor layer of the photoconductor drum 11, however, several hours may be required in order that the charged state of the surface of the photoconductor drum 11 at about −100 V completely attenuate to 0 V.

When a subsequent image forming operation is started before the surface potential of the photoconductor drum 11 attenuates to 0 V after the end of the previous image forming operation, the region of the surface of the photoconductor drum 11 that is charged at about −100 V may move to a position where the region faces the developing roller 141 of the developing device 14 and the toner may adhere to the region due to the potential difference from the surface of the photoconductor drum 11.

In the second exemplary embodiment, as illustrated in FIG. 12, the control part 101 measures the elapsed time from the end of the previous image forming operation and changes the value of the developing bias voltage having the reverse polarity to that for the image formation and applied to the developing roller 141 depending on the elapsed time from the end of the previous image forming operation.

When the elapsed time from the end of the previous image forming operation is short, the surface potential of the charged photoconductor drum 11 may remain about −100 V.

Therefore, the control part 101 predicts the surface potential of the photoconductor drum 11 based on the elapsed time from the end of the previous image forming operation. When the elapsed time from the end of the previous image forming operation is short, a voltage of about 0 V is applied to the developing roller 141 of the developing device 14 as the reverse-polarity developing bias voltage Vd0 as illustrated in FIG. 12.

At the start of the subsequent image forming operation, the control part 101 changes the reverse-polarity developing bias voltage Vd0 to be applied to the developing roller 141 of the developing device 14 to a voltage of about +100 V depending on the elapsed time from the end of the previous image forming operation.

### Third Exemplary Embodiment

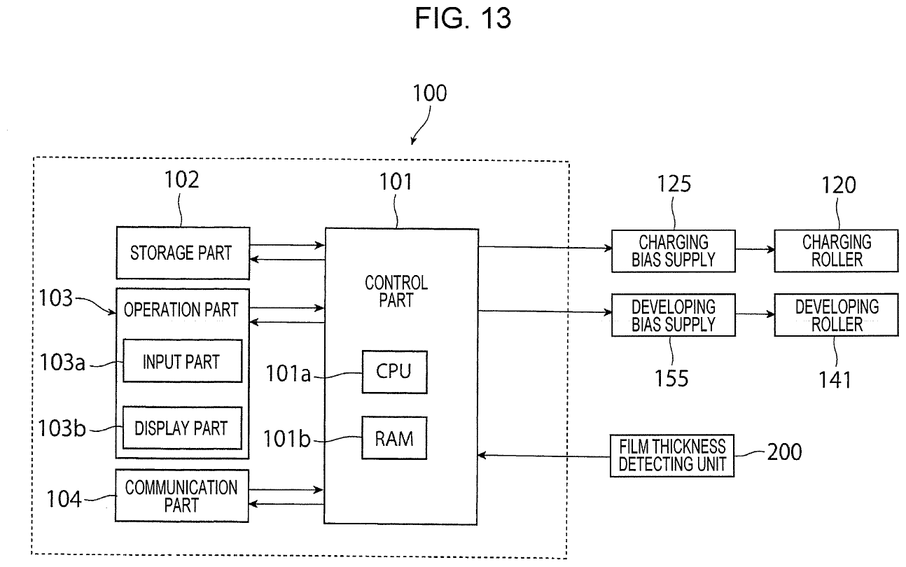

FIG. 13 illustrates an image forming apparatus according to a third exemplary embodiment of the present disclosure. The third exemplary embodiment provides a film thickness detecting unit that detects a change in the film thickness of the photoconductor layer of the photoconductor drum 11. The applying unit changes the developing bias voltage to be applied to the developing roller of the developing device based on a detection result from the film thickness detecting unit.

That is, as illustrated in FIG. 13, the third exemplary embodiment provides a film thickness detecting unit 200 that detects the film thickness of the photoconductor layer of the photoconductor drum 11 by counting a cumulative number of rotations of the photoconductor drum 11 or a cumulative number of sheets of recording paper 5 having images formed thereon.

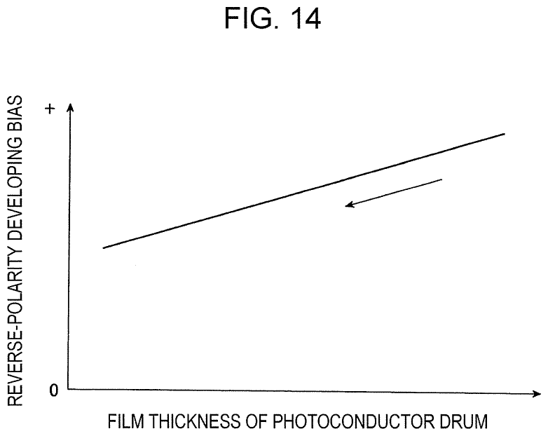

As illustrated in FIG. 14, the control part 101 changes, based on a detection result from the film thickness detecting unit 200, the value of the reverse-polarity developing bias voltage Vd to be applied to the developing roller 141 of the developing device 14 to a gradually decreasing value along with a decrease in the film thickness of the photoconductor layer of the photoconductor drum 11.

### Fourth Exemplary Embodiment

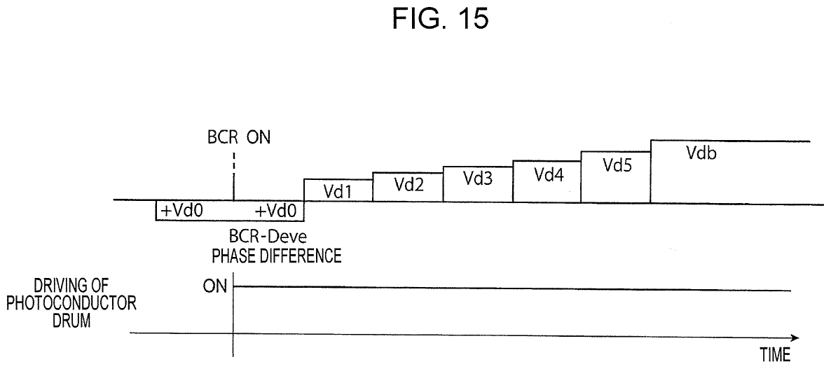

FIG. 15 illustrates an operation of an image forming apparatus according to a fourth exemplary embodiment of the present disclosure.

In the fourth exemplary embodiment, as illustrated in FIG. 15, at the start of the image forming operation, the developing bias voltage Vd0 having the reverse polarity to that for the image formation is applied to the developing roller 141 of the developing device 14 prior to the start of rotational driving of the photoconductor drum 11.

The exemplary embodiments described above are applied to the full-color image forming apparatus but may similarly be applied to a monochrome image forming apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus, comprising:
a rotary image carrying unit;
a charging unit that comprises a charging roller and charges a surface of the image carrying unit;
a developing unit that comprises a developing roller and develops an electrostatic latent image formed on the surface of the image carrying unit; and
a power supply circuit that applies, to the developing unit, a developing voltage having a reverse polarity to a polarity for image formation during a period from a start of charging the surface of the image carrying unit to a time when an uncharged region of the surface of the image carrying unit reaches the developing unit.

2. The image forming apparatus according to claim 1, wherein the power supply circuit changes a value of the developing voltage having the reverse polarity to the polarity for the image formation and applied to the developing unit depending on an elapsed time from an end of a previous image forming operation.

3. The image forming apparatus according to claim 2, wherein the power supply circuit changes the developing voltage to be applied to the developing unit depending on the elapsed time from the end of the previous image forming operation so that a difference from a charging potential of the image carrying unit falls within a predetermined range.

4. The image forming apparatus according to claim 1,
wherein the power supply circuit changes the developing voltage to be applied to the developing unit based on a change in a film thickness of the image carrying unit.

5. The image forming apparatus according to claim 4, wherein the power supply circuit changes a value of the developing voltage to be applied to the developing unit to a smaller value along with a decrease in the film thickness of the image carrying unit.

6. The image forming apparatus according to claim 1, wherein the power supply circuit applies, to the developing unit, the developing voltage having the reverse polarity to the polarity for the image formation before the image carrying unit starts to rotate.

7. The image forming apparatus according to claim 2, wherein the power supply circuit applies, to the developing unit, the developing voltage having the reverse polarity to the polarity for the image formation before the image carrying unit starts to rotate.

8. The image forming apparatus according to claim 3, wherein the power supply circuit applies, to the developing unit, the developing voltage having the reverse polarity to the polarity for the image formation before the image carrying unit starts to rotate.

9. The image forming apparatus according to claim 4, wherein the power supply circuit applies, to the developing unit, the developing voltage having the reverse polarity to the polarity for the image formation before the image carrying unit starts to rotate.

10. The image forming apparatus according to claim 5, wherein the power supply circuit applies, to the developing unit, the developing voltage having the reverse polarity to the polarity for the image formation before the image carrying unit starts to rotate.

11. An image forming apparatus, comprising:
rotary image carrying means;
charging means that comprise a charging roller for charging a surface of the image carrying means;
developing means that comprise a developing roller for developing an electrostatic latent image formed on the surface of the image carrying means; and
a power supply circuit for applying, to the developing means, a developing voltage having a reverse polarity to a polarity for image formation during a period from a start of charging the surface of the image carrying unit to a time when an uncharged region of the surface of the image carrying means reaches the developing means.
